(19) United States
(12) Patent Application Publication
(10) Pub. No.: US 2011/0133695 A1
(43) Pub. Date: Jun. 9, 2011

(54) Power Tool Battery Cell Replacement Kit and Methods Thereof

(76) Inventor: Richard Cadway, San Diego, CA (US)

(21) Appl. No.: 12/634,668

(22) Filed: Dec. 9, 2009

(51) Int. Cl. H02J 7/00

(52) U.S. Cl. 320/114

(57) ABSTRACT

The present invention relates generally to a kit which allows replacement of a removable battery cell cluster from a power tool which is no longer viable or operational and replacing it with a new battery cell cluster so to operate the power tool normally. The invention further relates to methods of replacing the expired battery cluster and assembling the new battery cluster so that it is attachable to the power tool and so that it is easily transported by the user while working with the power tool.

### FIELD OF THE INVENTION

The present invention relates generally to a kit which provides a user the ability to assemble an external or internal battery cluster in order to replace a battery cell cluster from a power tool battery that is no longer operational, so to operate the power tool normally. The invention further relates to methods of replacing the expired battery cluster and assembling the external battery cluster so that it is attachable to the power tool and so that it is easily transported by the user while working with the power tool.

### BACKGROUND OF THE INVENTION

Portable power tools rely upon rechargeable battery technology for convenience as well as adaptability in performing specific tasks. The importance of rechargeable battery and power tool portability in the construction industry as well as in performing everyday tasks around the home cannot be overstated. Rechargeable batteries are manufactured using many different chemistries, including nickel-based reactions such as nickel metal hydride (NiMH) and nickel cadmium (NiCd), and lithium-based reactions such as lithium ion and lithium polymer chemistries. Specific advantages of each of these chemistries are realized however, none offer an optimal battery configuration which solves the shortcomings of current battery technology platforms. For example, lithium batteries have the specific advantage of generally being lighter weight as well as possessing an overall higher energy density than other battery types and are generally more expensive than other battery types. Nickel based battery platforms are disadvantaged by higher weight and larger size per output but offer the advantage of providing higher peak current capability and lower cost.

Modernly, hand-held devices such as cell phones generally require low battery power output and as such, lithium based chemistries have stood out as an ideal battery platform in powering such devices. Moreover, lithium based batteries are generally very lightweight and do not add an inordinate amount of weight to the phone. Power tool applications, such as drills, routers and saws for example, generally require higher peak currents than that provided by lithium cells. Given these requirements, nickel based battery cells are generally employed for power tool applications. While nickel cells work well in providing sufficient battery output for power tool operability and are relatively inexpensive, they are also a toxic vector to the environment which is compounded by their prevalence in the marketplace. NiMH batteries are more relatively expensive but have a greater current output and many manufacturers are building tool batteries using this chemistry versus the NiCD battery platform. Further, as lithium chemistries have improved in power output and reliability, prices have come down for this battery type and manufacturers have designed new lines of cordless power tools using lithium batteries. Given the tendency of power tool users to keep their old tools even when new tools are available millions of nickel type batteries ultimately remain in use. When manufacturers offer cordless power tools using NiCD batteries there is usually no other alternative to the manufacturers batteries. The present invention addresses many of these issues by allowing users to replace the NiCD cell cluster in the original NiCD battery with new NiCD cells more powerful NiMH cells that are much more environmentally friendly due to their lack of cadmium, a known toxic heavy metal.

Previous attempts at solving these shortcomings have been attempted however disadvantages of current battery chemistries persist. For example, U.S. Pat. No. 6,106,971 issued to Spotnitz describes one such solution in which the weight of the nickel battery is dispersed throughout the clothing of the power tool operator thus saving the user the burden of holding the weight of the battery over his head. However, overcoming the disadvantage of weight in this manner requires the user to utilize special clothing in which the batteries are either sewn into the clothing or in which the clothing is fitted with specialized pockets which allow coupling of the battery cells in parallel. Such requirements render this solution unduly expensive and an impractical route for non-professionals performing ordinary household tasks. In addition, heavy use of batteries housed in clothing causes the generation and build up of heat, causing the cells to become very hot. Such cells can even burn making it difficult for the user to remove the hot cells as they are housed in the user's clothing. The present invention can be slipped off easily in a few seconds without difficulty.

Other devices for supplying electrical power to power tools which utilize specialized clothing are well known in the art. For example, U.S. Pat. No. 4,667,362 discloses a device which has a holster for storing a tool with contacts which may be connected to batteries for recharging as well as a base which engages the holster. In this way, an electrical contact is established with the contact on the tool through openings in the holster. U.S. Pat. No. 4,827,534 describes a solar power vest, containing numerous photovoltaic cells and connected with one another for charging rechargeable batteries. The batteries are arranged in carrying cases clipped on the belt or suspended from the belt or other article of clothing. Similarly, U.S. Pat. No. 5,211,321 describes a battery and an equipment vest in which a plurality of pocket compartments are provided for accommodating batteries and a charger. U.S. Pat. No. 6,501,197 describes a power tool provided with a remote battery pack with batteries arranged on the battery belt and connected with one another and to a tool through a cable. A common feature among these devices is that the batteries are housed within clothing, with batteries attached to the clothing or belt. By contrast, the present invention creates a battery by employing use of the elastic belt and battery cells. Hence, the user is wearing the battery, whereas the prior art describes battery devices which are housed in clothing.

Likewise, there are numerous examples of attempts in providing tool users with options in powering their portable work tools. For example, U.S. Pat. No. 5,076,805 to Welch describes a handheld power tool with an adapter that replaces the battery normally placed in the battery compartment of the device, where the adapter is capable of connecting to an external automotive battery. In U.S. Pat. No. 5,354,215 to Viracola, an interconnecting circuit element is placed in an internal battery compartment of the power tool which connects the power tool to a power source socket, such as a cigarette lighter socket in an automobile. However, hand tool battery output voltages vary among manufacturers and few, if any, correspond to the 12 volts of automotive batteries. To make such a device practical for everyday use, transformers would be required to provide the correct voltage to the tool, rendering the device impractical for the everyday household power tool user. In addition, such alternative power sources require that the user be within some reasonable distance of the alternate power source so that a power cord can be extended from the source to the power tool. Requirements in this regard significantly limit the portability of power tools in proximity to the source as well as in manipulation of the power tool by the user.

There have also been few, if any, solutions in providing the art with an apparatus and methods for replacing defective battery cells for power tools when, as commonly occurs, one or two cells of the existing power tool battery short circuit or become defective following an extended use over a period of time. Because most power tools utilize numerous cells connected in series, if one cell short circuits or becomes defective, the entire power source is rendered useless.

It is therefore, an object of the present invention to provide users of power tools the ability to replace and rebuild power tool battery clusters in a cost-effective and time efficient manner by providing an apparatus and methods for replacing the non-functioning battery cluster with a new external rechargeable battery cluster that can be used in its place. It is further an object of the present invention to replace the non functioning battery cells or cell cluster within the rechargeable battery pack with new cells with an external cell cluster in an easily worn bandolier or belt.

It is further an object of the present invention to provide a battery cluster source for power tools that allows maximum portability and the ability to adjust voltage so that the battery pack can be used on a variety of different power tools, which require various voltages, using the same battery pack. In utilizing the present invention a user is provided the ability to power any tool for example, using a NiMH battery, which provides greater power output and run time. The present invention also allows a user to “overclock” a power tool by providing the tool a higher voltage, a capability not realized in the prior art. It is also an object of the present invention to allow users the ability to replace the battery cluster for their respective power tools by providing professionals and non-professionals alike the ability to readily produce the battery pack according to any desired voltage and power output, without the need for specialized welding equipment.

### SUMMARY OF THE INVENTION

The invention provides an external battery cluster kit for an electrically powered tool comprising, a fabric bandolier belt which is worn by a user wherein, the bandolier belt using elastic material holds a plurality of rechargeable battery cells, the battery cells being electrically connected to one another with a plurality of electrical contacts and electrical connectors which are attached to the battery cells to produce an electric current to power the tool. The invention further provides a battery cluster that is electrically connected to the tool by means of primary and secondary cables, wherein a first end of the primary electrical cable is connected to the battery cluster by a secondary electrical cable and a second opposite end of the primary electrical cable is connected to another secondary electrical cable, the secondary electrical cable being connected to a battery pack appropriate for the tool, allowing the user to recharge the battery cluster using the recharger provided with the power tool. In addition, the battery cluster provides an electric current and sufficient voltage to power the tool for normal operation, wherein the voltage may be modulated by the user with an electrical switch in series on the battery cluster to provide electrical power to a variety of tools which require different operating voltages. Finally, the external battery cluster provides a bandolier belt that is attached to a tool holster appropriate for holding the electrically powered tool.

Also provided is a method of assembling an external battery cluster worn by a user to power an electrically powered tool by connecting a plurality of rechargeable battery cells to one another with electrical contacts and connectors which are attached to the battery cells to produce a battery cell cluster, the battery cluster producing an electric current to power the tool. The invention further provides contacts and connectors are rotatable and allow flexibility of the battery cluster while in use and wherein the battery cell cluster is electrically connected to the power tool by means of primary and secondary cables. In this regard, a first end of the primary electrical cable is connected to the battery cell cluster by a secondary electrical cable and a second opposite end of the primary electrical cable is attached to another secondary electrical cable that is electrically connected to a battery housing, wherein the battery housing fits the tool thus allowing the battery to be recharged using the power tool battery recharger and wherein the electrical current provides sufficient voltage to power the tool for normal operation. In this regard, the voltage may be modulated by the user with an electrical switch connected in series on the battery cluster to provide electrical power to a variety of tools which require different operating voltages. Further, the bandolier belt is attached to a tool holster appropriate for holding the electrically powered tool.

The invention further provides a method of constructing an internal battery cluster to power an electrically powered tool by allowing a user to connect a plurality of rechargeable battery cells to one another with electrical contacts and connectors, wherein the contacts and connectors are rotatable and allow flexibility of the battery while in use. Further, the battery cells of the invention are housed within a battery pack supplied by the manufacturer of the power tool which has had the factory-supplied battery cell cluster removed, thus allowing the internal battery cluster to be recharged using the power tool battery recharger. Finally, the invention provides an internal battery cluster that contains a switch in series with the cluster that allows a user to modulate the voltage delivered to a particular tool.

### BRIEF DESCRIPTION OF THE DRAWINGS

FIG. 1 depicts the external battery cluster invention in its entirety as worn by a user. The bandolier fits over the shoulder of the user allowing distribution of the weight of the battery and easier transport of the battery in awkward working conditions. The power tool is fitted into a tool holster attached to the bandolier via a Velcro connection.

FIG. 2 depicts the external battery cluster in its entirety absent the user and showing how the battery cells 8 of the invention fit into the bandolier belt. The figure also illustrates the electrical connections between the battery cells and the power tool battery housing.

FIG. 3A depicts a front view of the bandolier belt absent the battery cells with the Velcro connections which secure the belt to the body of the user as well as secure the tool holster to the belt.

FIG. 3B depicts a back view of the bandolier belt absent the battery cells. The figure further illustrates the Velcro connection sections.

FIG. 3C depicts a top view of the bandolier belt absent the battery cells. The figure further illustrates the placement and configuration of the Velcro connecting sections so to securely fit to a user's body and also secure the power tool holster to the belt.

FIG. 4 depicts the configuration of the Velcro sections of the invention.

FIG. 5 depicts further configurations of the Velcro sections of the invention which secure the tool holster to the bandolier belt.

FIG. 6A illustrates the inside section of the belt depicting the Velcro sections with the tool holster attached. The figure shown faces toward the user's body.

FIG. 6B depicts an inside view of the tool holster 3 secured to the Velcro section of the bandolier belt. The figure shown faces outward away from the user.

FIG. 7 depicts the electrical configuration of the battery cells connected in series with positive and negative terminals shown. As shown, the battery cells are placed inside battery cell “pockets” created by an elastic strip sewn into the fabric bandolier belt.

FIGS. 8A and 8B depict the bandolier belt containing cells in series with a multi-voltage switch incorporated for use with a variety of tools requiring varying operating voltage requirements, with positive and negative terminals shown. Specifically, FIG. 8A illustrates the belt with the battery cells connected in series. In addition, a multi-voltage switch 21 is shown. FIG. 8B depicts a multi-voltage switch 21 which allows a user the ability to manually change the amount of voltage that is delivered to the power tool.

FIG. 9 depicts an illustrated version of the bandolier belt containing battery cells connected in series with positive and negative terminal regions shown. Also shown is the electrical connection from the battery cells to the quick connects leading to the battery housing in a power tool.

FIG. 10 illustrates the configuration of individual battery cells and the method in which the electrical contacts and connectors are prepared and connected on the battery cell. To create an electrical current and voltage, the electrical contacts and connectors are placed on both sides of the battery cell and housed within the battery pocket holders of the belt. The illustration also depicts the connection between electrical contacts and electrical connectors to establish an electrical current.

FIG. 11 shows a top view of the battery cluster indicating how the electrical contacts and connectors join each of the battery cells to create an electrical circuit.

FIG. 12A illustrates the electrical connecting (i.e., electrical connector) wire as it is configured just prior to being placed inside the electrical contact to establish an electrical current.

FIG. 12B illustrates the electrical connector as it is configured after being placed inside the electrical contact to establish an electrical current.

FIG. 13 illustrates the 360° degree level of rotation which the electrical contact is capable of engaging when connected to the electrical connector wire. Contacts assembled from “male” and “female” contact fittings can be rotated to allow maximum flexibility in the battery cluster.

FIG. 14 illustrates a side angle view of the electrical contact with the lower male portion 29 of the contact spot welded to the battery cell and the female portion of the contact 28 engaged with the electrical connecting wire 27 (i.e., electrical connector).

FIG. 15 illustrates the electrical contact with the male and female portions engaged with one another secured on a battery cell.

FIG. 16 illustrates the external battery cluster in which the battery cells are connected by spot welding metal tab connectors with electrical connecting wires soldered to establish an electrical current.

FIG. 17 illustrates the external battery cluster in which the battery cells are connected by an alternative embodiment of the electrical contacts of the invention. In the illustration, a male portion of the connector 23 is spot welded to the battery cell and a female connector 32 is engaged therein. A connecting wire 27 establishes the electrical current between battery cells.

FIG. 18 illustrates the configuration of the battery cells as they are situated in the bandolier belt and details the arrangement of a preferred embodiment of the electrical contacts and connectors. As shown, a male section 29 of the 2-prong electrical contact is spot welded to the battery cell and engaged with the female portion 28 of the contact, which is connected to an electrical connecting wire 27.

FIG. 19 depicts the configuration of the battery cells in yet another preferred embodiment of electrical contacts and connectors. As shown, the contact includes a 4-pronge electrical contact that is secured to the battery cell and connected to an electrical connecting wire to establish an electrical current.

FIG. 20A illustrates the primary electrical cable 6 which connects the external battery cluster to the battery pack of a power tool (via quick connects 56, 57, 58, 59) which has had the factory supplied internal battery cluster removed. A second set of quick connects 34, 35, 36, 37 connect the primary electrical cable to the “post-type” battery pack 5 shown with an electrical connection established at metal contacts 39, 40 in the “post” of the pack as indicated by the positive and negative terminal connections. As shown, the secondary electrical cable located in the “post-type” battery case is electrically connected to the post cell 38 in the battery pack.

FIG. 20B depicts an alternative to the quick connects in which male 51 and female 52 connectors are employed to establish an electrical connection between the external battery cell cluster, the primary electrical cable and the battery pack.

FIG. 21 illustrates an alternative embodiment of the external battery cluster in which the cluster is manually portable with battery cells configured in a fabric belt and connected to establish an electrical circuit to power an electrically powered tool.

FIG. 22 illustrates the portable battery cluster with the belt secured to provide the user a battery “handle” for manually transporting the battery cluster. As shown, the electrical connecting wires 22 establish an electrical current by connecting to metal tab contacts that are secured to the battery cells, which are connected in series.

FIG. 23 illustrates portable external battery cluster as it is assembled for manual portability by a user.

FIG. 24 illustrates an internal battery cluster placed in a battery pack absent the factory supplied battery cluster. As shown, the internal battery cluster is assembled using the electrical contacts and connectors which are then placed in a “slide-in” version of a battery pack. The electrical connection establishes an electrical current at the electrical contacts inside of the battery pack 39, 40 and the outside of the pack 55 to power the tool.

FIG. 25 depicts yet another embodiment of the invention in which caps are used to protect each of the battery cells which are electrically connected. The caps also serve to accommodate the secondary electrical cable so to run the length of the battery cluster. As shown, the cap 60 fits over the top of the electrical contact while also holding the secondary electrical cable in place. In a related embodiment, the cap will incorporate a “U-shape” to accommodate the secondary electrical cable to run along the length of the battery cluster.

FIGS. 26A and 26B provide a side view of the battery cell caps as they are fitted over the electrical contacts. Specifically, 26A shows the cap fitted over the entire contact while holding the secondary electrical cable 22 in a wire channel 61. As shown, the cap attaches to the contact via a clip 63 that attaches the end cap to the connector 62. FIG. 26B illustrates how the secondary electrical cable runs the length of the cap and how it is incorporated with the contact as well as the electrical connector 27.

FIG. 27 depicts an overhead view of the cap of the invention as it is fitted over an electrical contact and battery cell. As shown, the figure illustrates that the secondary electrical cable runs through the center of the cap and allows for coverage of the entire electrical contact. Further, a second perspective of the electrical connector 27 is shown engaged into the contact.

### DETAILED DESCRIPTION OF THE INVENTION

Portable power tools rely upon rechargeable battery technology for convenience as well as adaptability in performing specific tasks. Currently, there is a need for improved methods in providing power to electric power tools, which will convey cost savings, safety and an environmentally friendly option with regard to electrically powered tools, to the everyday do-it-yourself consumer as well as to the professional craftsman. Power tools modernly readily utilize rechargeable battery technology however, with the limited lifetime these battery packs provide, consumers and professionals are left with few options in continuing to use their power tools once the battery pack is spent and cannot be recharged or in the instance in which the manufacturer stops making batteries for their older tools. In such cases, the power tool user has little choice but to undertake the significant expense of purchasing replacement battery packs directly from the manufacturer since most manufacturers make significant efforts to keep rechargeable batteries as non-standard as possible, forcing consumers to return when the battery pack is spent and no longer functional. Moreover, the professional as well as non-professional must incur the expense of purchasing replacement battery packs for each brand and voltage of power tool since battery packs are rarely, if ever, interchangeable.

Accordingly, the invention relates to a rechargeable battery kit and battery cluster which utilizes a bandolier fabric belt designed to hold in place a plurality of commercially available battery cells using elastic, which is worn by a user. In a primary embodiment of the invention, the battery cells are connected to one another to create a battery cluster and electric current utilizing a plurality of electrical contacts and electrical connectors which are attached to the battery cells. The electric current produced by the battery cells is transferred from the battery via a primary electrical cable to the battery pack of an electrically powered tool.

In a preferred embodiment of the invention an appropriate number of battery cells connected in series are utilized which will provide sufficient power for normal operation of the tool. In such an embodiment the battery cells are connected via a primary electric cable, in series, parallel or a combination of both, to a secondary cable that is electrically attached to the battery housing of the power tool. To prepare connections, the primary and secondary electrical cables are connected by utilizing quick connects to establish an electric circuit between the battery cluster and the battery pack housing of the tool. Further related to this embodiment are a multiple series of battery cells that are electrically connected in parallel to increase the available current to the power tool.

In a related embodiment of the invention the number of battery cells necessary to provide sufficient power for normal operation to a particular power tool is exceeded. In such an embodiment, the voltage of the battery cells is modulated by a user by employing use of a switch to supply various voltages from the battery kit to various tools that require different operational voltages for normal operation.

In yet another preferred embodiment the bandolier belt is attached using a Velcro attachment to a power tool holster that appropriately holds the particular power tool to be used. In the instance in which a bandolier belt is employed to hold battery cells, the belt will contain an elastic housing which hold in place each battery cell of the invention and which will also hold various types and sizes of individual battery cells in operation of the battery kit. The present invention further provides Velcro sections which secure the fabric bandolier belt and holster and break away and separate from one another when accidentally snagged in a work environment, thus providing a measure of safety to the user

The term “fabric bandolier belt” as used herein refers to a belt configured to house the rechargeable battery cells of the invention. The belt can be prepared from any materials appropriate for industrial use. To house the individual battery cells an elastic material is employed and sewn into the belt to accommodate various sized battery cells if necessary. The bandolier belt also incorporates use of Velcro to secure a tool holster to the belt for use by an individual in performing work with the power tool being powered by the battery cluster.

The term “external battery cluster” as used herein refers to the portion of the invention in which rechargeable battery cells are connected in series and housed in the bandolier belt and located outside (i.e., externally) of the battery pack associated with a particular power tool. External battery clusters can also be connected in parallel to other serial battery clusters of the invention.

The term “internal battery cluster” as used herein refers to the invention in which rechargeable battery cells are connected in series to power the tool and which are housed within the battery pack of a power tool absent the factory supplied battery cells.

The term “battery cells” as used herein refers to battery cells that are rechargeable and which may be connected to other battery cells via electrical connections secured to the cells. An example of such rechargeable battery cells include nickel cadmium, lithium, nickel met-hydride-based batteries. Other battery types known in the industry are also encompassed within the scope of the invention. Also encompassed by the present invention, “battery cells” as used herein also refer to cells of varying sizes, lengths and power outputs. For example, such battery cells include sub-c and/or 4/5 sub-c type cells.

The term “rechargeable battery cells” as used herein refers to battery cells that are amenable to recharging using a recharger or by other means known in the art.

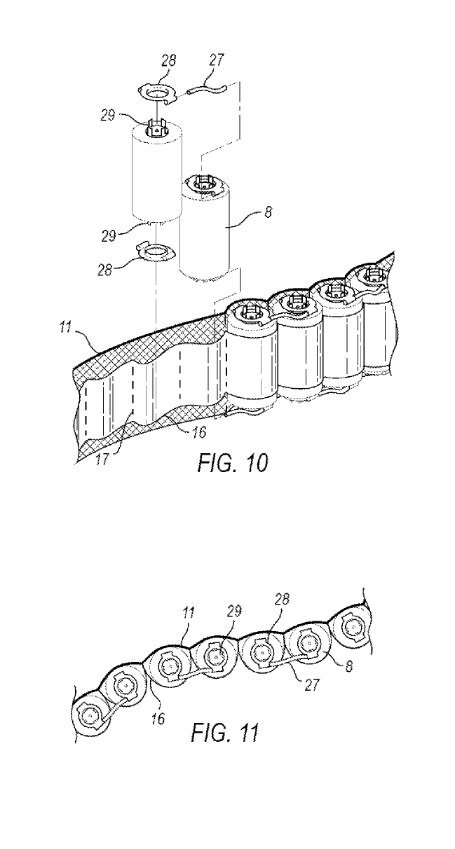

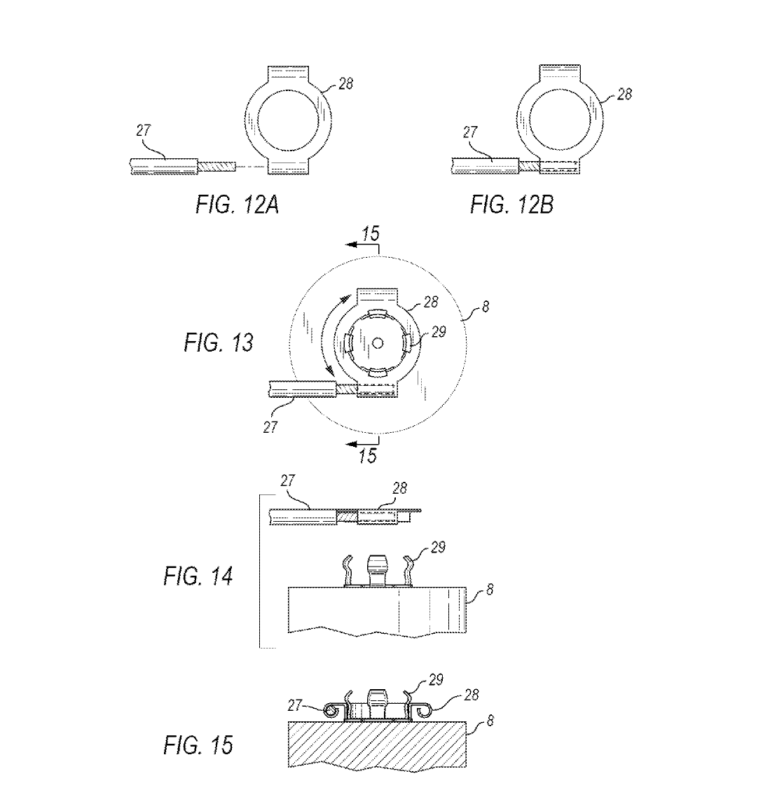

The term “electrical contacts” as used herein refers to several different embodiments that are employed to establish an electrical connection between battery cells. For example, FIGS. 10, 12A, 12B among others, show alternative electrical contact embodiments of the present invention. For instance, FIG. 14 shows a female/male version of an electrical contact within the scope of the invention. Likewise, FIG. 19 illustrates an alternative embodiment of the electrical contacts of the present invention. Specifically, FIG. 19 illustrates a single contact (i.e., no male or female sections) with 4-prongs used to engage an electrical connecting wire (i.e., electrical connector). Contacts include single, double, triple or quadruple prongs for engaging a multiple number of electrical connectors.

The term “electrical connectors” or “connecting wires” as used herein refers to an electrical wire employed to establish an electrical connection between battery cells. More specifically, the electrical connectors of the present invention are electrically conducting wires that engage and connect electrical contacts that are secured to a battery cell to allow electrical power to flow between battery cells.

The term “electrically connected” (with regard to electrical contacts) as used herein refers to the establishment of a connection between battery cells which allows the flow of electrical power in series or in parallel to power an electrically powered tool. For example, battery cells electrically connected in series will provide sufficient voltage to power a tool.

The term “attached” with regard to contacts, as used herein refers to connection of electrical contacts to the terminal ends of a battery cell by methods known in the art. For example, an electrical contact “attached” to a battery cell may be attached by spot welding or other methods known in the art.

The term “primary electrical cable” as used herein refers to an electrical cable or wire capable of carrying sufficient current from the external battery cluster of the invention to a battery pack which has had the previously supplied battery cell cluster removed. The primary electrical cable within the scope of the invention encompasses cable or wire of varying gauges to accommodate varying flows of voltage to a power tool. Specifically, the primary electrical cable is connected directly with the battery cluster via use of quick connects and a secondary electrical cable as described herein.

The term “secondary electrical cable” as used herein refers to an electrical cable(s) or wire(s) capable of carrying sufficient current from the external battery cluster of the invention to the battery pack which has had the manufacturer supplied battery cluster removed. The secondary electrical cable within the scope of the invention encompasses cable or wire of varying gauges to accommodate varying flows of electrical current to a power tool. For example, as used herein, one first end of a secondary electrical cable is connected directly to the primary electrical cable with the second end connected to the terminals of a battery pack. Likewise, one first end of another secondary electrical cable is connected to the battery cluster with the second end connected to the primary electrical cable. In the case in which a power tool is a 2- or 3-speed version, the secondary electrical cable as contemplated herein will employ multiple wires to establish the electrical connection between the battery cluster and the power tool. The secondary electrical cable may also be referred to as a tertiary electrical cable.

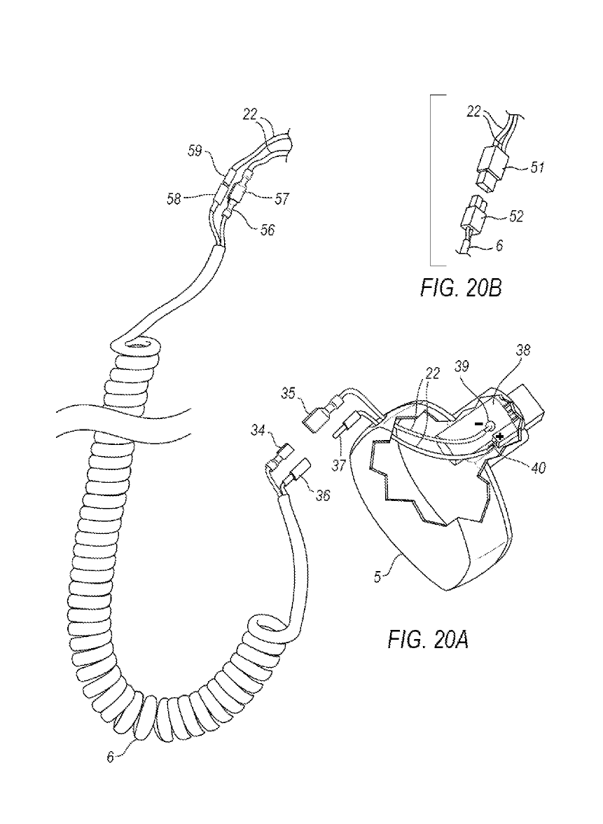

The term “battery housing”, “battery pack” or “battery pack housing” as used herein refers to the battery cell housing supplied by the power tool manufacturer with a particular power tool which has been removed of the manufacturer supplied battery cluster within. For example, such a battery housing or pack is illustrated in FIGS. 20A (5) and 24 (50). As contemplated in the present invention, the manufacturer supplied battery cluster is removed once it is no longer operational or no longer holds a charge. In turn, the external battery cluster of the present invention is attached to metal contacts of the battery pack housing. In the case of the internal battery cluster of the present invention, the cluster is placed directly within the battery pack housing and electrically connected to the metal contacts of the battery pack housing.

The term “modulated” as used herein refers to the ability of a user of the present invention to alter or vary the amount of power or voltage supplied to a particular power tool. For instance, in the case in which a power tool requires 18 volts for normal operation, the present invention allows a user to modulate the power output so that the external battery cluster can be varied to provide power to another tool which requires, for example, 14.4 volt for normal operation. Likewise, modulation as contemplated herein also refers to the ability of a user of the external battery cluster to provide power to an electrically powered tool via battery cells connected either in series or in parallel.

The term “attached” with regard to the holster as used herein refers to securing the tool holster to the fabric bandolier belt so that the holster is not pulled off the belt while in use but alternatively, will separate the holster from the belt in the event that the belt is accidentally snagged resulting in danger to the user. In other words, the term attached allows the belt to “break away” in the event the tool holster is accidentally snagged. In such an instance, the tool holster will release from the user preventing injury to the user. In releasing the holster from the user, the invention provides a safety measure in the work environment in which the user is engaged. As contemplated herein, Velcro is employed to secure the tool holster to the bandolier belt.

Encompassed in the present invention is an external and internal battery cluster and methods of assembling a battery cluster to be employed in replacing the spent battery clusters provided with certain power tools by manufacturers. It is well known that over time and extended use, the battery clusters of rechargeable batteries are eventually rendered inoperable and cannot be recharged to operate the power tool with which they are provided. The present invention solves this shortcoming by providing a user the ability to assemble a new battery cluster for the tool thus allowing the user to continue use of the power tool without having to purchase a second manufacturer battery for the tool. Moreover, the present invention allows a user to utilize a single external battery cluster to power a variety of different power tools, even in the instance in which those power tools require various voltages for normal operation.

In a preferred embodiment assembly of the external battery cluster employs use of rechargeable battery cells electrically connected via electrical contacts and electrical connectors. The battery cells are connected either serially, in parallel or in a combination thereof. The electrical contacts of the invention encompass a variety of designs as shown in the Figures. For example, a 2-prong version of contact, as shown in FIG. 10, is included in the scope of the present invention. In this embodiment, the contact is prepared from “female” 28 and “male” 29 sections that engage one another when in use. In this embodiment, two connecting wires 27 can be employed to create an electrical circuit.

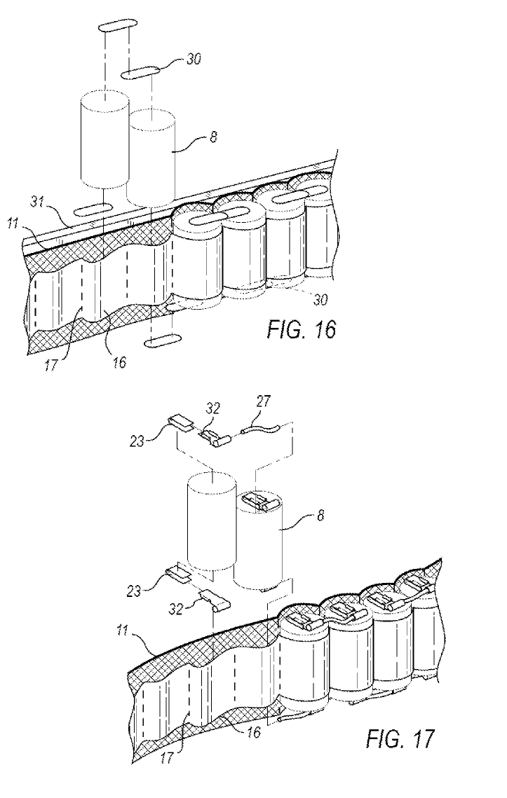

In yet another preferred embodiment, metal tabs are employed as shown in for example, FIG. 16, by spot welding the tabs 30 to the battery cells and creating an electrical circuit. In another preferred embodiment other types of connectors are employed to create the electrical circuit. For example, metal connectors such as shown in FIG. 17 may be used to create the required electrical circuit. In yet another embodiment, a 4-prong electrical contact is employed as shown in FIG. 19.

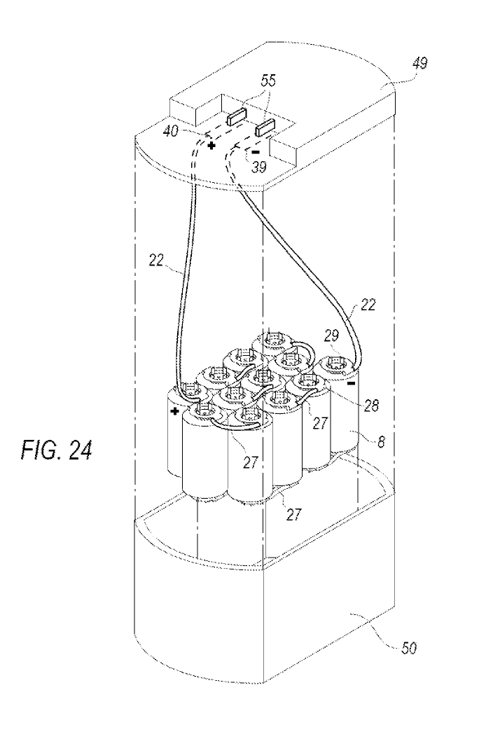

In order to power an electrical power tool, several variations of transferring electrical current are contemplated in the present invention. For example, a primary electrical cable 6 is employed to electrically connect the external battery cluster to the battery pack. An electrical connection between the external battery cluster and the battery pack is established via the use of quick connects 56, 57, 58, 59 as shown in FIG. 20A. Another set of quick connect devices 34, 35, 36, 37 are employed to establish the electrical connection between the primary electrical cable and the secondary electrical cable 22. The secondary electrical cable is then electrically connected to the metal contacts in either a “post-type” battery pack or a “slide-in” type of battery housing, as shown in FIG. 20A and FIG. 24. In addition, the quick connects create a level of safety as they can be pulled apart if the wire becomes accidentally snagged in the work environment.

In another embodiment of the invention, the external battery cluster can be prepared into an internal battery cluster wherein the electrically connected battery cells are placed directly within the manufacturer provided battery housing pack following removal of the non-functioning battery cluster. In such a configuration, the internal battery cluster is electrically connected directly to the metal contacts in either the “post-type” or “slide-in” battery pack housing. In this embodiment the belt, as well as the primary electrical cable, are not necessary since the internal battery cluster is situated within the battery pack housing.

In yet another embodiment of the external battery cluster, the belt is configured to form a “handle” so that a user can easily hand carry the battery cluster around a work environment. As shown in FIGS. 21, 22 and 23, the belt is prepared with Velcro which is secured to form a handle which allows the electrical connection from the battery cluster and the secondary battery cable to the primary electrical cable followed by connection to the battery housing.

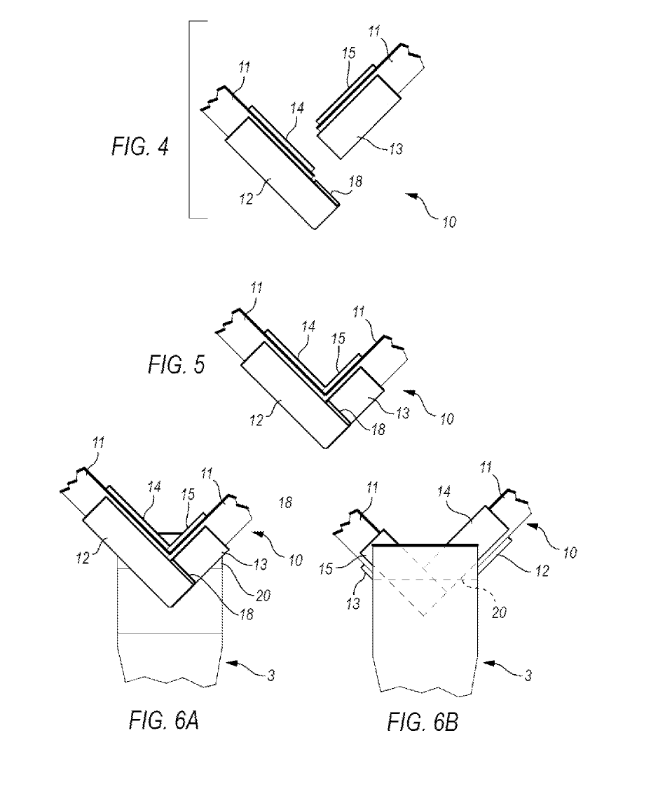

In another embodiment of the invention, the fabric bandolier belt is configured in order to provide a safety measure to the user in awkward working environments. For example, FIGS. 4, 5 and 6 show the configuration of the Velcro which will “break away” in the event a user of the belt gets the belt snagged on a nail or other implement while working. In such an instance, the belt can break away via the Velcro connections with the intention of allowing the user to maintain his balance and stability.

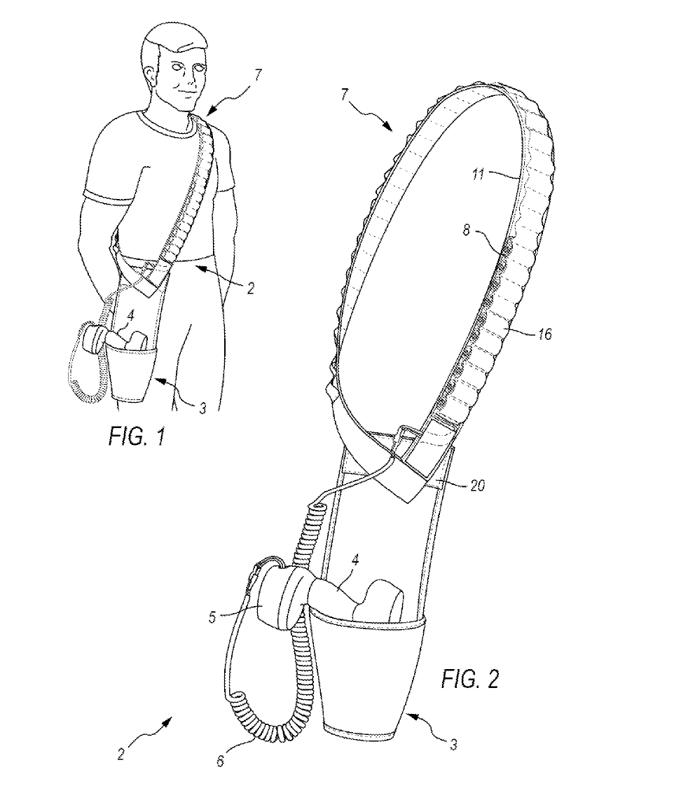

Reference is now made to FIGS. 1-27, which illustrate various embodiments of the invention.

FIGS. 1 and 2 show a preferred embodiment of the invention. Specifically, the fabric bandolier belt 7 is shown worn by a user while attached and electrically connected to a power tool 4 while stored in a tool holster 3. One or more bandoliers may be worn, one over each shoulder and yet another can be worn around the waist if necessary. In the Figures the rechargeable battery cells 8 are shown and located in battery holders 16 in the belt. As shown, the tool holster 3 is secured with Velcro 20 which is sewn into the bandolier belt.

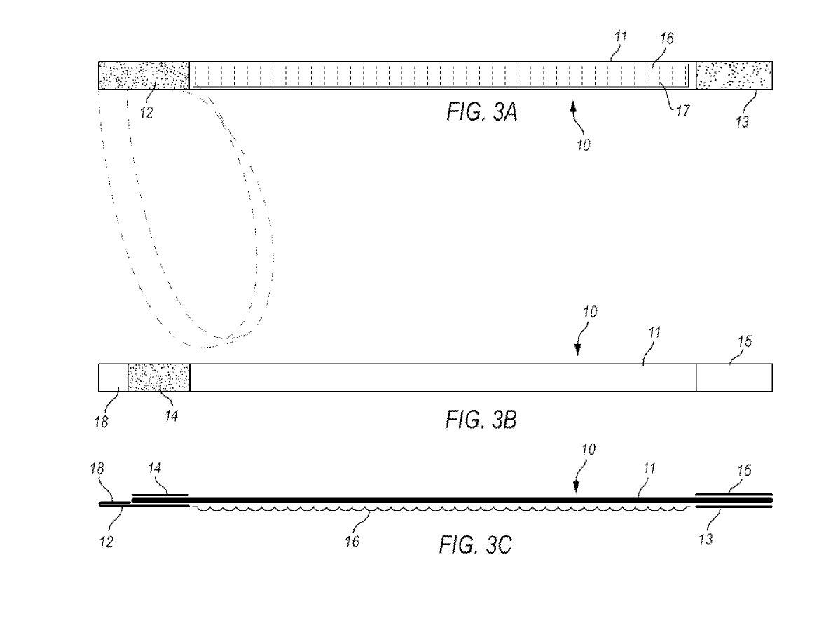

FIGS. 3A, 3B, and 3C illustrate the fabric bandolier belt and the configuration of Velcro which provides a measure of safety to the user when the belt is accidentally snagged in a work environment causing the user to lose his balance. FIG. 3A shows a front view of the bandolier belt and how the belt is folded around the user's shoulder or waist. FIG. 3B illustrates the backside view of the bandolier belt. FIG. 3C in particular shows the configuration of Velcro 12, 13, 14, 15, 18 and a top view of the bandolier belt 10, 11.

Specifics on the configuration of the Velcro are shown in FIGS. 4, 5, and 6. To begin, Velcro sections 12, 14 are sewn onto one end of the bandolier belt while other sections 13, 15 are sewn onto the second end of the belt. FIG. 5 illustrates how the two ends of the bandolier belt are secured together to fit over the user's shoulder, with Velcro 13 fitting onto another section of Velcro 18.

FIG. 6A shows how the tool holster is secured to the bandolier belt 11 being worn by a user. The perspective provided in the Figure is a view toward the user. To secure the holster 3, a section of Velcro is sewn onto the holster 20 and secured to the Velcro 14, 15 on the bandolier belt. FIG. 6B illustrates a view of the tool holster as viewed looking away from the wearer. Also shown is how it is configured to be secured to the bandolier belt.

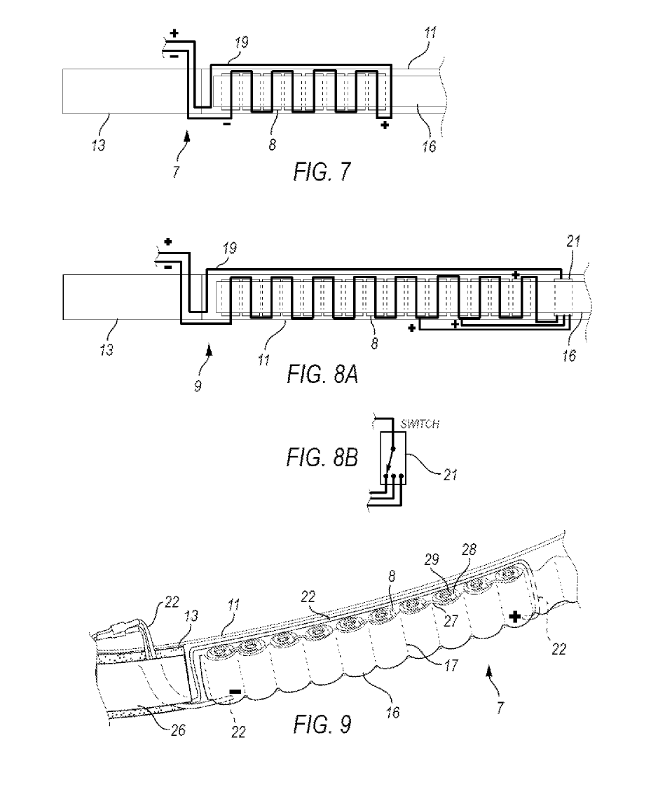

According to a preferred embodiment of the invention, FIG. 7 illustrates the electrical connection between the rechargeable battery cells 8 while located in the bandolier belt 11. As shown, the electrical current 19 is illustrated as it runs along the length of the battery cluster. FIGS. 8A and 8B illustrate the entire bandolier belt and battery cluster and includes a multi-voltage switch 21 providing the user the ability to change the voltage output 19 and allow use of the battery cluster with different power tools that may require different operating voltages. Positive and negative terminal connections are illustrated in FIGS. 7 and 8A but such terminal locations will depend on how the battery cluster is assembled.

FIG. 9 shows a preferred embodiment of the invention. Specifically, the battery cells 8 are shown with electrical contacts 28, 29 (female and male) secured to the battery cell by spot welding. The battery cells are held by elastic battery holders 16 which are sewn into the bandolier belt with seams 17 to house individual cells. The battery cells are connected with electrical connectors 27 to establish an electrical current which leads to the secondary electrical cable 22. The secondary electrical cable is secured to the bandolier belt by employing use of Velcro sections 13, 26 sewn into the belt 11. In a related embodiment the elastic battery holders are fitted with cooling vents or holes to allow dissipation of heat during use of the battery cluster.

FIG. 10 shows a preferred embodiment of the invention in which a 2-prong female/male 28, 29 electrical contact is employed with an electrical connector 27 to establish an electrical current. Each cell 8 is connected in series and individual cells held in place in the belt with elastic battery cell holders 16 that have been sewn 17 into the belt. FIG. 11 illustrates a top or bottom view of the battery cells as they are in an electrically connected configuration.

FIGS. 12A and 12B illustrate how the electrical connectors 27 engage the electrical contacts of the invention. First, the electrical connector is pushed into one of the prongs and engaged into the female portion of the contact 28 where it is secured by crimping the prong or soldering. The engaged female portion is then engaged onto the male portion of the contact 29 as shown in FIGS. 13, 14 and 15. In this preferred embodiment, the male portion of the contact 29 is spot welded onto each ends of the battery cell as shown in FIG. 15.

In a related embodiment, FIG. 16 provides metal tabs 30 that are employed and attached to the appropriate end of the battery cell by spot welding or other like methods. Thereafter, the metal tabs are soldered to one another to establish an electrical current. To maintain a level of stiffness in the belt and to prevent the breakage of electrical connection between the battery cells, the belt 11 is also prepared with a stiff backing 31 so to render the belt less prone to over flexing to the point that electrical contact is lost between cells. The stiffener in this embodiment allows slight bending of the material and belt while also springing back into position when not under pressure. As contemplated herein, any material which acts to stiffen (i.e., allows some flexing under pressure while springing back to position when not under pressure) the belt can be employed.

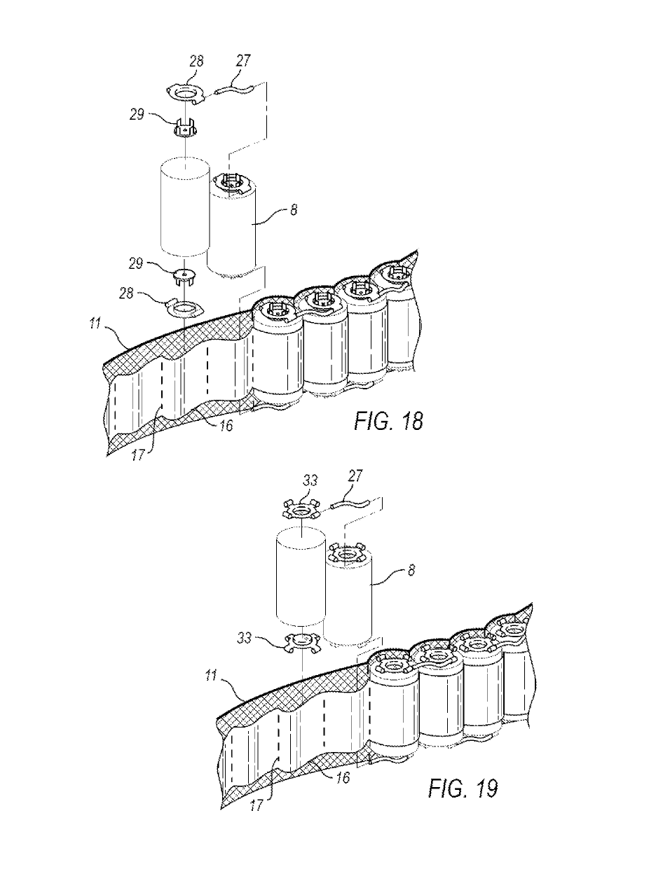

FIG. 17 shows a related embodiment that employs use of a different type of electrical contact from those previously shown. In this related embodiment a “male” contact 23 is secured to the appropriate end of the battery cell by spot welding or the like and a second “female” contact 32 is engaged therein. The female contact 32 is electrically connected to other battery cells via an electrical connector 27 (connecting wire) to establish an electrical current. FIG. 18 illustrates another rendering of a preferred embodiment of the contacts of the invention. In this embodiment, the male 29 contact section is spot welded to the both ends of the battery cell with individual cells electrically connected to one another with connecting wires 27. The “female” contact section 28 is then engaged onto the “male” section of the contact. FIG. 19 shows an alternative preferred embodiment with a 4-prong electrical contact 33. In this embodiment, the female/male sections of the contact are replaced with a single piece contact 33, which is attached to the appropriate end of the battery cell by spot welding. Utilizing this type of contact allows assembly of a battery in which up to four connecting wires 27 may be employed to establish an electrical current.

Attention is now drawn to FIGS. 20A and 20B which illustrate the electrical connections between the external battery cluster and the primary electrical cable as well as the connection between the primary electrical cable and the battery pack and power tool. Specifically, the secondary electrical cable extending from the battery cluster 22 is connected to a primary electrical cable 6 by employing use of quick connects 56, 57, 58, 59. Next, the primary electrical cable is connected to another secondary electrical cable with a second set of quick connects 34, 35, 36, 37 which in turn, is attached to the metal contacts of the battery pack to deliver current to the power tool. Alternatively, to establish connections between the secondary and primary electrical cables female 52 and male 51 connectors are employed as shown in FIG. 20B.

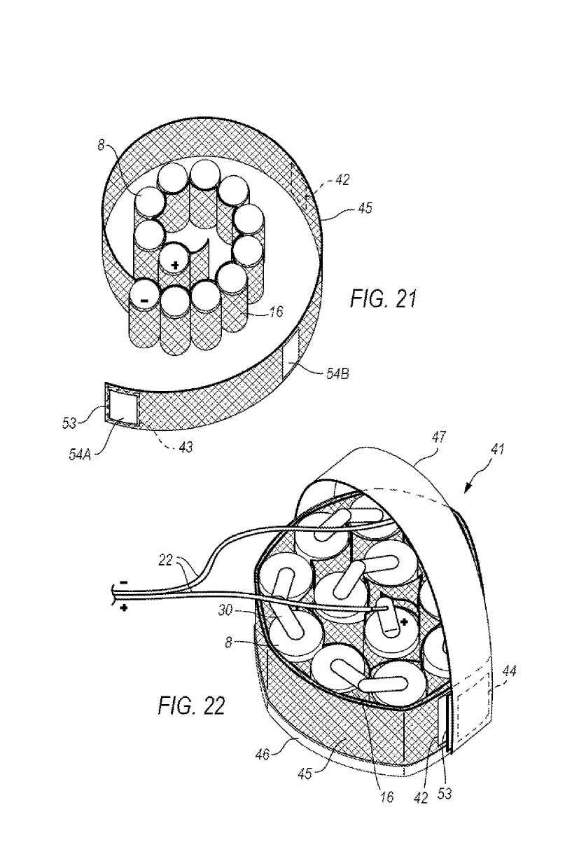

FIGS. 21, 22 and 23 illustrate an alternative embodiment of the external battery cluster. Specifically, FIG. 21 illustrates a primary fabric belt 45 with battery cell holders 16 and battery cells 8. The belt is fitted with Velcro sections 42, 43, 53 sewn into the belt to secure the individual battery cells. Positive and negative terminals are shown. FIG. 22 depicts the secondary electrical cable 22 attached to metal tabs 30 which electrically connect each of the battery cells. In this Figure, a second section of belt 47 is shown and is attached to the Velcro sections of the primary belt 45. The second belt section is secured by Velcro to the first belt of this Figure by employing use of several sections of Velcro 42, 43, 44, 53, 54A, 54B. In this embodiment the second belt section forms a “handle” for easy hand portability of the external battery cluster at a work site. This embodiment also employs use of a portable pack bottom 46 which acts to insulate and protect the bottom of the cells from the surface on which the batteries sit. The portable pack bottom is attached to the belt 45 and also acts to hold the battery cells in place.

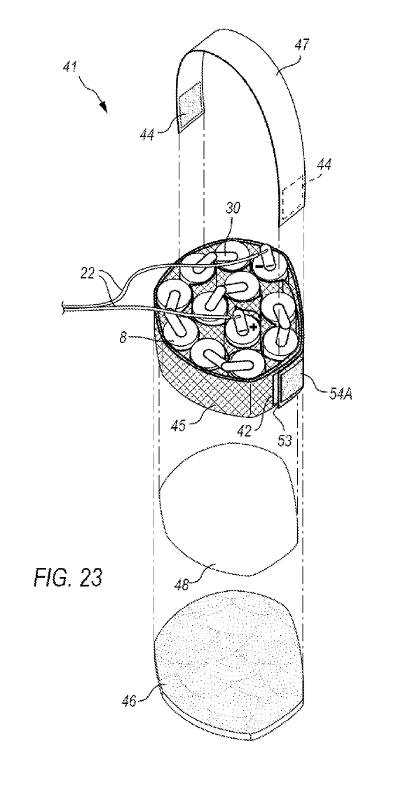

FIG. 23 illustrates the full assembly of the alternate embodiment of the external battery cluster. Specifically, the fabric belt 45 surrounds the cluster of battery cells which have been electrically connected to one another via electrical contacts 30 and the secondary electrical cable 22. The fabric belt 45 is secured to a portable pack bottom 46 which holds the battery cells in place. The pack bottom is secured to the fabric belt 45 via a Velcro section 48 which holds the two pieces together. Finally, the second fabric belt acts as a “handle” and is attached to the fabric belt 45 by Velcro attachments. As previously described a multi-voltage switch 21 can be incorporated into this embodiment of the external cluster to allow modulation of the voltage for the cluster to be used with various power tools.

FIG. 24 illustrates an alternative embodiment of the invention and constitutes an internal battery cluster. Specifically, battery cells are electrically connected as previously described using appropriate electrical connectors 27 and contacts 28, 29 with an electrical current transferred via a secondary electrical cable 22 to the metal tab contacts 39, 40 of the battery pack 49, 50. In this embodiment the internal battery cluster employs use of the manufacturer's provided housing absent the spent battery cluster that was originally supplied with the housing.

In a related embodiment, the battery housing shown in FIG. 24 will have an extended battery pack housing bottom 50 to accommodate a variety of battery cell size so to provide greater electrical power to the tool if necessary. For example, many commercially available battery packs are supplied with sub-c internal battery clusters. Employing the electrical connectors and contacts of the present invention, 4/5 sub-c battery cells are required in order to properly fit within the manufacturer-supplied battery pack. Alternatively, in order to employ use of sub-c battery cells and the electrical contacts and connectors of the invention, an extended lower battery pack housing 50 is utilized so to provide greater clearance within the battery housing for the cells, contacts and connectors 28, 29. By using an extended lowered housing, sub-c cell types may be employed to provide more electrical current and power to the tool. In this embodiment, the extended lower housing provides sufficient volume and space to accommodate an internal battery cluster composed of sub-c cells and also provides sufficient clearance for the electrical contacts and connectors to operate normally.

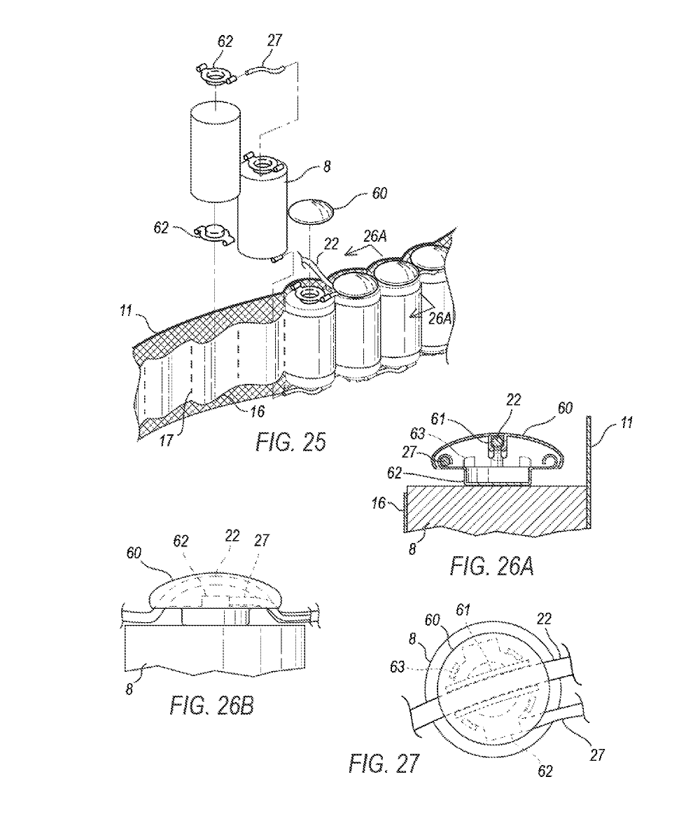

FIG. 25 depicts a related embodiment to the external battery clusters of the invention. Specifically, a cap 60 is utilized in order to provide protection to the battery cells 8 electrically connected in series. In addition, the caps serve to house the secondary electrical cable 22 as it runs the length of the battery cluster.

FIGS. 26A and 26B illustrate two side view perspectives of the battery cell cap. FIG. 26A shows a complete coverage of the cap when placed over the electrical contact with an accommodation made for the secondary electrical cable 22. A clip 63 is shown which acts to attach the end cap to the connector 62. In addition, the electrical connector 27 is shown engaged in the cap. The 45° degree side version of FIG. 26B (vs. FIG. 26A) depicts the secondary electrical cable as it runs the length of the cap and shows engagement of the electrical connector 27 in place.

FIG. 27 illustrates an overhead view of the cap 60 with the electrical contacts and connector shown in dotted lining. As described, the secondary electrical cable runs the length of the cap with the electrical connector 27 set offset and adjacent the center.

Certain advantages are realized in the scope of the invention including minimizing the number of discarded power tools and utilizing rechargeable batteries which decreases the number of batteries discarded into the environment. Other advantages realized in the invention include various safety features including a “break away” Velcro belt which if snagged during use, will break away and not trap the wearer of the bandolier. In addition, a second safety feature allows the holster to break away from the belt should it become accidentally snagged. Moreover, the electrical connectors act as an added safety feature in that they also break away should the cable of the invention become snagged. Yet another safety feature and advantage in the invention is the ability for a user to easily wear the battery pack thus, eliminating fatigue during long periods of use. Also, the flexibility provided by the invention allows a user to contort into any number of positions which may be required in various work environments.

Yet another advantage is realized by the ability to utilize the same battery cluster for a multitude of different brand power tools, even in the instance in which the power tools require various voltages for normal operation. The voltage switch utilized in the present invention allows a user to for example, use the battery cluster on a 14.4 volt power drill, then with a fast switch of the voltage, the user can disconnect the battery kit from the particular power tool and quickly attach it to another battery housing appropriate for another power tool and operate at 18 volts. Further, a user may employ the power tool battery housing to charge the battery of the present invention.

These advantages result in significant cost savings to the user since the same battery may be used to power all the user's power tools negating the need to purchase replacement rechargeable battery packs for each individual power tool. There is a prevailing need in the field of commercial and personal construction to provide users of power tools the ability to effectively and safely power their tools while realizing significant cost savings. The present invention addresses this and other critical needs currently deficient in the prior art. For example, a user employing the present invention to power four different power tools would decrease the amount of hazardous materials and spent batteries entering the environment by 75%.

Although the invention has been described with reference to the above example, it will be understood that modifications and variations are encompassed within the spirit and scope of the invention. Accordingly, the invention is limited only by the following claims.

What is claimed is:

1. An external battery cluster kit for an electrically powered tool comprising, a fabric bandolier belt which is worn by a user wherein, the bandolier belt using elastic material holds a plurality of rechargeable battery cells, said battery cells being electrically connected to one another with a plurality of electrical contacts and electrical connectors which are attached to the battery cells to produce an electric current to power the tool, wherein the battery cluster is electrically connected to the tool by means of primary and secondary cables, wherein a first end of said primary electrical cable is connected to the battery cluster by a secondary electrical cable and a second opposite end of said primary electrical cable is connected to another secondary electrical cable, said secondary electrical cable being connected to a battery pack appropriate for the tool, allowing the user to recharge the battery cluster using the recharger provided with the power tool, wherein said electric current provides sufficient voltage to power the tool for normal operation, wherein said voltage may be modulated by the user with an electrical switch in series on the battery cluster to provide electrical power to a variety of tools which require different operating voltages and wherein said bandolier belt is attached to a tool holster appropriate for holding said electrically powered tool.

2. The battery cluster of claim 1, wherein Velcro sections which secure the fabric bandolier belt and holster, break away and separate from one another, when accidentally snagged in a work environment, providing a measure of safety to the user.

3. The battery cluster of claim 1, wherein the fabric bandolier belt contains elastic battery cell pockets that stretch to accommodate holding a variety of battery cell sizes and types.

4. The battery cluster of claim 1, wherein the electrical contacts comprise the contacts essentially as shown in FIG. 10, 11, 12A, 12B, 14, 15, 16, 17, 18 or 19.

5. The electrical contacts of claim 4, further comprising contacts composed of brass, nickel or alloys of nickel, phosphor bronze or beryllium copper.

6. The electrical contacts of claim 5, wherein a male portion of said contacts rotate 360° relative to a female portion of the contact to provide the battery kit with flexibility during use.

7. The battery cluster of claim 1, wherein the tool holster is attached to the bandolier belt with a Velcro attachment.

8. The battery cluster of claim 1, further comprising rechargeable battery cells composed of nickel metahydride (NiMH), nickel cadmium (NiCD) or Lithium ion.

9. The battery cluster of claim 1, wherein the rechargeable battery cells are electrically connected serially, in parallel or a combination of both.

10. The battery cluster of claim 1, further comprising a fabric handle that attaches to the belt which allows the user the ability to hand-carry the battery cluster during use.

11. The battery cluster of claim 1, further comprising battery cell caps that cover the electrical contacts of the battery cluster and house the secondary electrical cable, providing protection to the cells and electrical connections.

12. A method of assembling an external battery cluster worn by a user to power an electrically powered tool comprising the steps of connecting a plurality of rechargeable battery cells to one another with electrical contacts and connectors which are attached to the battery cells to produce a battery cell cluster, said battery cluster producing an electric current to power the tool, wherein said contacts and connectors are fixed or rotatable and allow flexibility of the battery cluster while in use and wherein the battery cell cluster is electrically connected to the power tool by means of primary and secondary cables, wherein a first end of the primary electrical cable is connected to the battery cell cluster by a secondary electrical cable and a second opposite end of the primary electrical cable is attached to another secondary electrical cable that is electrically connected to a battery housing, wherein the battery housing fits the tool thus allowing the battery to be recharged using the power tool battery recharger and wherein said electrical current provides sufficient voltage to power the tool for normal operation, wherein said voltage may be modulated by the user with an electrical switch connected in series on the battery cluster to provide electrical power to a variety of tools which require different operating voltages, wherein said bandolier belt is attached to a tool holster appropriate for holding said electrically powered tool and wherein the belt and holster act as a safety device in which the Velcro sections separate from one another when the belt or holster are accidentally snagged in a work environment, providing the user a measure of safety.

13. The method of claim 12, wherein the fabric bandolier contains elastic battery cell pockets that stretch to accommodate holding a variety of battery cell sizes and types.

14. The method of claim 12, wherein the electrical contacts comprise the contacts essentially as shown in FIG. 10, 11, 12A, 12B, 14, 15, 16, 17, 18 or 19.

15. The method of claim 14, wherein said contacts are comprised of brass, nickel or alloys of nickel, phosphor bronze or beryllium copper.

16. The method of claim 12, wherein a male portion of said contacts rotate 360° relative to a female portion of the contact to provide the battery kit with flexibility during use.

17. The method of claim 12, wherein the tool holster is attached to the bandolier belt with a Velcro attachment.

18. The method of claim 12 further comprising rechargeable battery cells that are nickel metahydride (NiMH), nickel cadmium (NiCD) or Lithium ion.

19. The method of claim 12, wherein the rechargeable battery cells are electrically connected serially, in parallel or in a combination of both.

20. A method of constructing an internal battery cluster to power an electrically powered tool comprising the steps of connecting a plurality of rechargeable battery cells to one another with electrical contacts and connectors, wherein said contacts and connectors are fixed or rotatable and allow flexibility of the battery while being assembled and wherein the battery cells are housed within a battery pack supplied by the manufacturer of the power tool which has had the factory-supplied battery cell cluster removed, allowing the internal battery cluster to be recharged using the power tool battery recharger.
